(19) United States
(12) Patent Application Publication
(10) Pub. No.: US 2016/0372029 A1
(43) Pub. Date: Dec. 22, 2016

(54) DISPLAY DEVICE AND METHOD OF REPAIRING THE SAME

(71) Applicant: SAMSUNG DISPLAY CO., LTD., Yongin-si (KR)

(72) Inventors: Kyong Tae Park, Yongin-si (KR); Dong Hoon Jeong, Yongin-si (KR); Yu Hyun Cho, Yongin-si (KR)

(21) Appl. No.: 15/019,812

(22) Filed: Feb. 9, 2016

(30) Foreign Application Priority Data
Jun. 16, 2015 (KR) 10-2015-0085445

(51) Int. Cl. G09G 3/3208; G09G 3/00

(52) U.S. Cl. CPC G09G 3/3208; G09G 3/006; G09G 2330/10; G09G 2330/08; G09G 2300/0413

(57) ABSTRACT

A display device includes a plurality of pixels at respective crossing regions of data lines and scan lines, a plurality of repair lines in parallel with the scan lines, one or more dummy pixels coupled to a respective one of the repair lines, one or more dummy data lines that are respectively coupled to the one or more of the dummy pixels, and that overlap the data lines, and a test line coupled between a first test pad and the dummy pixels, wherein one of the dummy pixels at an ith (i is a natural number) horizontal line includes a dummy pixel circuit between a kth (k is a natural number) dummy data line of the dummy data lines and an ith repair line of the repair lines, and a coupling unit coupled between the ith repair line and the test line.

### CROSS-REFERENCE TO RELATED APPLICATION

This application claims priority to, and the benefit of, Korean Patent Application No. 10-2015-0085445, filed on Jun. 16, 2015, in the Korean Intellectual Property Office, the entire contents of which are incorporated herein by reference in their entirety.

### BACKGROUND

1. Field

The present disclosure relates to a display device and a method of repairing the display device.

2. Description of the Related Art

As information technology has been developed, the importance of a display device, which is a coupling medium between a user and information, has been magnified. In response to this, a display device, such as a liquid crystal display device or an organic light emitting display device, is widely used.

A display device includes pixels, which are located in respective areas corresponding to crossing regions of scan lines and data lines, and also includes a scan driver that drives the scan lines, and a data driver that drives the data lines.

The scan driver supplies scan signals to the scan lines, and according to this, the pixels are selected as individual groups of pixels that are commonly arranged in a horizontal line unit. The data driver supplies data signals in synchronization with the scan signals. Accordingly, the data signals are supplied to the pixels selected by the scan signals, and the pixels emit light corresponding to the data signals.

The display device having the aforementioned configuration may be repaired by using laser or the like, such that a defective pixel may be normally driven.

### SUMMARY

According to the above, a method of checking a normal drive of the repaired pixel may be beneficial, and the present disclosure provides a display device that can check whether a repaired pixel is driven normally, and a method of repairing the display device.

A display device according to an embodiment of the present disclosure includes a plurality of pixels at respective crossing regions of data lines and scan lines in an active display area, a plurality of repair lines in parallel with the scan lines in the active display area, one or more dummy pixels in an area outside the active display area and coupled to a respective one of the repair lines, one or more dummy data lines that are respectively coupled to the one or more of the dummy pixels, and that overlap the data lines, and a test line coupled between a first test pad and the dummy pixels, wherein one of the dummy pixels at an ith (i is a natural number) horizontal line includes a dummy pixel circuit between a kth (k is a natural number) dummy data line of the dummy data lines and an ith repair line of the repair lines, and a coupling unit coupled between the ith repair line and the test line.

One or more of the one or more dummy pixels may be located at each horizontal line.

The coupling unit may include a diode that is configured to allow current to flow from the test line to the ith repair line.

The coupling unit may include at least one diode-connected transistor.

The coupling unit may include an inspection transistor coupled between a high potential voltage source and the ith repair line.

Each of the plurality of pixels may be configured to emit light while controlling an amount of a current that flows from a first power source to a second power source via an organic light emitting diode.

A voltage of the high potential voltage source may be higher than a voltage of the second power source.

The high potential voltage source may be the first power source.

A gate electrode of the inspection transistor may be coupled to the test line.

When an ith pixel of the pixels at an ith horizontal line fails the ith repair line may be configured to be electrically coupled to an organic light emitting diode of the ith pixel, and the kth dummy data line may be configured to be electrically coupled to a data line of the data lines coupled to the ith pixel.

The display device may further include a data driver that is configured to supply a data signal to the data lines.

The display device may further include one or more ring data lines electrically coupled to a dummy channel of the data driver, and a gate transistor coupled between the ring data line and a second test pad.

When a jth (j is a natural number) data line of the data lines is opened the ring data line may be configured to be electrically coupled to the jth data line, and the data driver may be configured to supply a data signal, which is the same as a data signal corresponding to the jth data line, to the dummy channel.

According to another embodiment of the present disclosure is a method of repairing a display device including a pixel at an ith (i is a natural number) horizontal line, and including an organic light emitting diode and a pixel circuit for supplying a current to the organic light emitting diode, the method including electrically decoupling the pixel circuit from the organic light emitting diode when the pixel fails, electrically coupling a dummy data line, which is coupled to a dummy pixel, to a data line coupled to the pixel, electrically coupling a repair line, which is coupled to the dummy pixel, to an anode electrode of the organic light emitting diode, and inspecting whether the organic light emitting diode emits light by using a coupling unit coupled to the repair line.

The coupling unit may include a diode configured to allow a current to flow from a first test pad to the repair line.

The inspecting whether the organic light emitting diode emits light may include supplying a high potential voltage to the first test pad.

The coupling unit may include an inspection transistor between the repair line and a high potential voltage source.

The inspecting whether the organic light emitting diode emits light may include turning on the inspection transistor to supply a voltage of the high potential voltage source to the organic light emitting diode.

The high potential voltage source may be a voltage by which the organic light emitting diode emits light.

The method may further include supplying a data signal corresponding to black to the data line during the inspecting whether the organic light emitting diode emits light.

### BRIEF DESCRIPTION OF THE DRAWINGS

Example embodiments will now be described more fully hereinafter with reference to the following detailed description of embodiments and the accompanying drawings, wherein:

FIG. 1 is a diagram schematically illustrating a display device according to an embodiment of the present disclosure;

FIG. 2 is a diagram more specifically illustrating arrangement of dummy pixels and pixels illustrated in FIG. 1;

FIG. 3 is a diagram illustrating a pixel according to an embodiment of the present disclosure;

FIGS. 4A and 4B are waveform diagrams illustrating a method of driving the pixel illustrated in FIG. 3;

FIG. 5 is a diagram illustrating the dummy pixel according to an embodiment of the present disclosure;

FIG. 6 is a diagram illustrating an embodiment of a diode illustrated in FIG. 5;

FIG. 7 is a diagram illustrating a repairing method according to an embodiment of the present disclosure;

FIG. 8A is a diagram illustrating an embodiment of a method of inspecting electrical coupling between a dummy pixel and an organic light emitting diode;

FIG. 8B is a diagram illustrating an embodiment of a method of driving the dummy pixel which is repaired;

FIG. 9 is a diagram illustrating a dummy pixel according to another embodiment of the present disclosure;

FIG. 10A is a diagram illustrating another embodiment of a method of inspecting electrical coupling between a dummy pixel and an organic light emitting diode;

FIG. 10B is a diagram illustrating another embodiment of a method of driving the dummy pixel which is repaired; and

FIG. 11 is a diagram illustrating repair processing of a data line using a ring data line.

### DETAILED DESCRIPTION

Features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein. Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section.

Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.”

As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

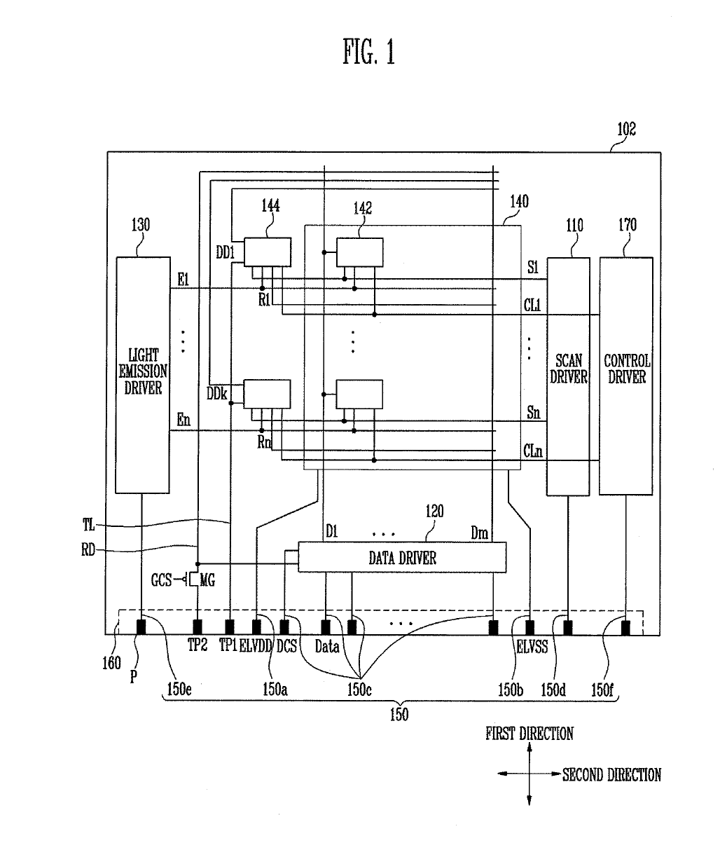

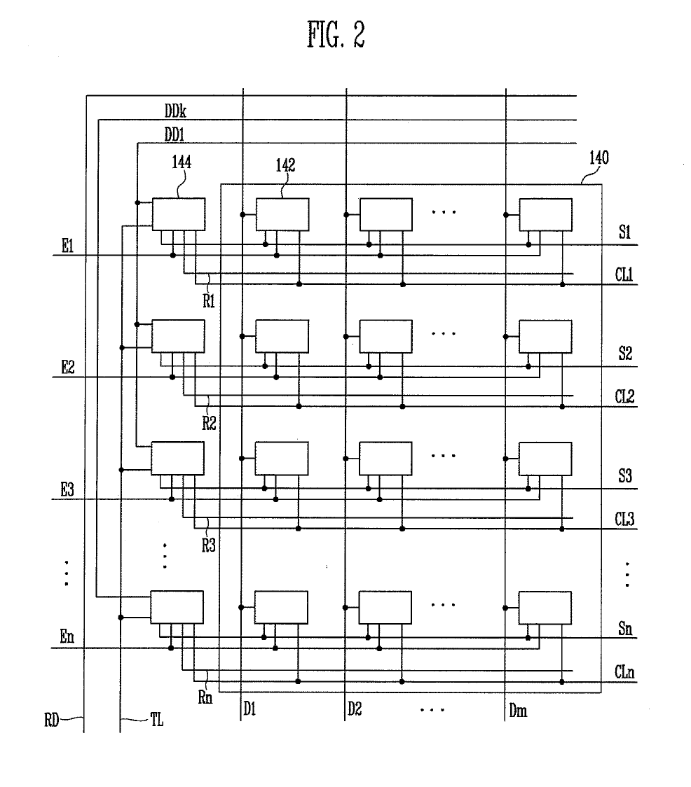

FIG. 1 is a diagram schematically illustrating a display device according to an embodiment of the present disclosure, and FIG. 2 is a diagram more specifically illustrating arrangement of dummy pixels and pixels illustrated in FIG. 1.

Referring to FIGS. 1 and 2, a display device according to an embodiment of the present disclosure includes a panel 102, a scan driver 110, a data driver 120, a light emission driver 130, a display area 140, a pad portion 160, and a control driver 170.

The display area 140 indicates an active display area in which images may be displayed, and includes a plurality of pixels 142 each respectively located at an area that is at a respective crossing region of a plurality of data lines D1 to Dm and a plurality of scan lines S1 to Sn. Each of the plurality of pixels 142 is selected when a scan signal is supplied to a respective one of the plurality of scan lines S1 to Sn, and receives a data signal from a respective one of the plurality of data lines D1 to Dm. The pixel 142 that receives the data signal emits light with a luminance corresponding to the data signal. To this end, each of the plurality of pixels 142 includes an organic light emitting diode. The pixels 142 are respectively coupled to the plurality of data lines D1 to Dm, which are formed in a first direction, and to the plurality of scan lines S1 to Sn, which are formed in a second direction. The plurality of pixels 142 may be additionally respectively coupled to a plurality of control lines CL1 to CLn, which are formed in the second direction, and to a plurality of light emission control lines E1 to En, which may also be formed in the second direction, in accordance with a circuit configuration.

A plurality of dummy pixels 144 are formed in a non-display area (that is, an area that is not included in the active display area 140) of the panel 102. At least one of the plurality of dummy pixels 144 may be respectively coupled to each horizontal line. Each of the plurality of dummy pixels 144 coupled to a respective one of the plurality of horizontal lines is respectively electrically coupled to any one of a plurality of repair lines R1 to Rn. For example, the dummy pixel 144 coupled to an ith (i is a natural number) horizontal line may be electrically coupled to an ith repair line (Ri).

The plurality of repair lines R1 to Rn are used for repairing a respective one of the plurality of pixels 142. For example, if a pixel 142 located at the ith horizontal line fails, an organic light emitting diode included in the pixel 142 may be electrically coupled to the ith repair line Ri by a laser short. Accordingly, the organic light emitting diode included in the pixel 142 on the ith horizontal line is driven by a current flowing out from the dummy pixel 144 located at the ith horizontal line. The dummy pixel 144 is used for repairing the pixel 142 included in the display area 140, and does not include an organic light emitting diode.

In addition, the dummy pixel 144 is coupled to at least one of a plurality of dummy data lines DD1 to DDk (k is a natural number), which are formed in the panel 102. The plurality of dummy data lines DD1 to DDk are located at one side of the panel 102, and cross/overlap the plurality of data lines D1 to Dm. The plurality of dummy data lines DD1 to DDk may be coupled to the plurality of data lines D1 to Dm during a repair period.

The scan driver 110 receives scan drive power supply voltages and a scan control signal from an external device via the pad portion 160. The scan driver 110, upon receiving the scan drive power supply voltages and the scan control signal, is configured to supply the scan signals to the plurality of scan lines S1 to Sn. For example, the scan driver 110 may sequentially supply the scan signals to the plurality of scan lines S1 to Sn. In addition, and for the sake of convenience of description, FIG. 1 illustrates the scan driver 110 coupled to one pad, although the present disclosure is not limited thereto. For example, the scan driver 110 may be coupled to a plurality of pads in accordance with a plurality of scan drive power supplies and/or a plurality of scan control signals.

The data driver 120 is coupled to the plurality of data lines D1 to Dm. The data driver 120 receives data “Data” and a data control signal DCS from an external device via the pad portion 160. The data driver 120, upon receiving the data “Data” and the data control signal DCS, is configured to generate a plurality of data signals in synchronization with a plurality of scan signals, and is configured to supply the plurality of data signals to the plurality of data lines D1 to Dm, respectively. The data driver 120 may be formed in the panel 102, or may be embedded in the panel 102 as an integrated circuit.

The light emission driver 130 is coupled to the plurality of light emission control lines E1 to En. The light emission driver 130 receives light emission drive power supply voltages and a first control signal from an external device via the pad portion 160. The light emission driver 130, after receiving the light emission drive power supply voltages and the first control signal, is configured to supply the light emission control signals to the plurality of light emission control lines E1 to En. For example, the light emission driver 130 may sequentially supply the light emission control signals to the plurality of light emission control lines E1 to En, respectively. The light emission control signal that is supplied to an ith light emission control line Ei may overlap in time with a scan signal supplied to an (i−1)th scan line Si-1 and a scan signal supplied to the ith scan line Si. In addition, for the sake of convenience of description, FIG. 1 illustrates the light emission driver 130 coupled to one pad, although the present disclosure is not limited thereto. For example, the light emission driver 130 may be coupled to the plurality of pads in accordance with the light emission drive power supplies and the first control signal.

The control driver 170 is coupled to the plurality of control lines CL1 to CLn. The control driver 170 receives control drive power supply voltages and a second control signal from an external device via the pad portion 160. The control driver 170, after receiving the control drive power supply voltages and the second control signal, is configured to supply the control signals to the plurality of control lines CL1 to CLn. For example, the control driver 170 may sequentially supply the control signals to the plurality of control lines CL1 to CLn. In addition, for the sake of convenience of description, FIG. 1 illustrates the control driver 170 coupled to one pad, although the present disclosure is not limited thereto. For example, the control driver 170 may be coupled to the plurality of pads in accordance with the control drive power supplies and the second control signal.

The pad portion 160 includes a plurality of pads P that transmit power supply voltages and/or signals, which are supplied from an external device, to the panel 102.

The non-display area of the panel 102 includes a first wire group 150, a test line TL, and a ring data line RD to which the power supply voltages and/or signals from the pad portion 160 are supplied.

The first wire group 150 includes a first wire 150a, a second wire 150b, a third wire 150c, a fourth wire 150d, a fifth wire 150e, and a sixth wire 150f. The first wire 150a receives a first power source ELVDD from an external device, and transmits the received first power source ELVDD to the display area 140. The second wire 150b receives a second power source ELVSS from an external device, and transmits the received second power source ELVSS to the display area 140.

The first power source ELVDD, which is supplied to the display area 140, is supplied to the plurality of pixels 142 and the plurality of dummy pixels 144. The second power source ELVSS, which is supplied to the display area 140, is supplied to the plurality of pixels 142. Each of the plurality of pixels 142 controls an amount of a current, which is supplied from the first power source ELVDD to the second power source ELVSS in accordance with the data signal, and emits light with a luminance corresponding to the current. To this end, the first power source ELVDD is a voltage that is higher than the second power source ELVSS.

The third wire 150c receives the data “Data” and the data control signal DCS from an external device, and transmits the received data “Data” and data control signal DCS to the data driver 120. To this end, the third wire 150c may actually be a plurality of wires. The fourth wire 150d receives the scan drive power supply voltage and the scan control signal from an external device, and transmits the received scan drive power supply voltage and scan control signal to the scan driver 110. To this end, the fourth wire 150d may also be a plurality of wires.

The fifth wire 150e receives the light emission drive power supply voltages and the first control signal, and transmits the received light emission drive power supply voltages and first control signal to the light emission driver 130. To this end, the fifth wire 150e may be a plurality of wires. The sixth wire 150f receives the control drive power supply voltages and the second control signal, and transmits the received control drive power supply voltages and the second control signal to the control driver 170. To this end, the sixth wire 150f may be a plurality of wires.

The test line TL is formed between a first test pad TP1 and the plurality of dummy pixels 144. The test line TL receives a voltage via the first test pad TP1 from an external device. The voltage received at the test line TL is supplied during a repair period of the panel 102, and is used for checking whether or not the repaired pixel 142 is normally driven/normally operating.

The ring data line RD is coupled to a second test pad TP2 via a gate transistor MG. The ring data line RD is electrically coupled to a dummy channel of the data driver 120. The gate transistor MG is turned on during a repair period in response to a gate control signal GCS (an additional pad may be formed on the panel to receive the gate control signal GCS). Accordingly, the ring data line RD may receive a voltage from the second test pad TP2 during a repair period. In addition, the ring data line RD may receive the data signal from the dummy channel of the data driver 120 during a normal drive period.

In addition, the ring data line RD is formed on one side of the panel 102, and overlaps the plurality of data lines D1 to Dm (e.g., at a top of the panel 102). The ring data line RD may be electrically coupled to one of the plurality of data lines D1 to Dm during a repair period. To this end, one or more ring data lines RD may be formed in the panel 102. Detailed description thereof will be made later.

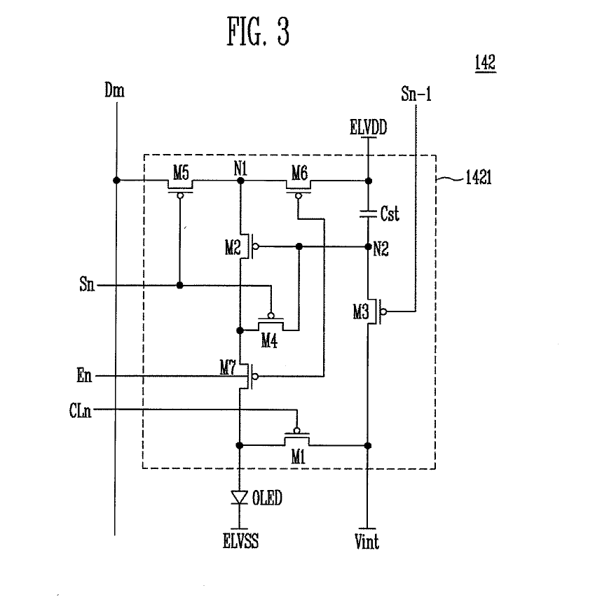

FIG. 3 is a diagram illustrating a pixel according to an embodiment of the present disclosure. For the sake of convenience of description, FIG. 3 illustrates the pixel coupled to the nth scan line Sn and the mth data line Dm.

Referring to FIG. 3, the pixel 142 according to an embodiment of the present disclosure includes an organic light emitting diode OLED, and a pixel circuit 1421 that controls an amount of a current that is supplied to the organic light emitting diode OLED.

The organic light emitting diode OLED emits light with a luminance corresponding to an amount of a current that is supplied from the pixel circuit 1421.

The pixel circuit 1421 receives the data signal from the data line Dm when the scan signal is supplied to the scan line Sn. The pixel circuit 1421 supplies a current corresponding to the data signal to the organic light emitting diode OLED. To this end, the pixel circuit 1421 includes first to seventh transistors M1 to M7, and a storage capacitor Cst.

The first transistor M1 is coupled between an anode electrode of the organic light emitting diode OLED and an initialization power supply voltage Vint. A gate electrode of the first transistor M1 is coupled to the control line CLn. When the control signal is supplied to the control line CLn, the first transistor M1 is turned on, and the initialization power supply voltage Vint is thereby supplied to the anode electrode of the organic light emitting diode OLED. The initialization power supply voltage Vint is set to be a voltage that is lower than the voltage of the data signal.

The second transistor M2 (driving transistor) has a first electrode coupled to a first node N1, and a second electrode coupled to a first electrode of the seventh transistor M7. A gate electrode of the second transistor M2 is coupled to a second node N2. The second transistor M2 controls an amount of a current flowing from the first power source ELVDD to the second power source ELVSS via the organic light emitting diode OLED, in accordance with a voltage of the second node N2.

The third transistor M3 has a first electrode coupled to the second node N2, and a second electrode coupled to the initialization power supply voltage Vint. A gate electrode of the third transistor M3 is coupled to the (n−1)th scan line Sn-1. When the scan signal is supplied to the (n−1)th scan line Sn-1, the third transistor M3 is turned on, thereby supplying the initialization power supply voltage Vint to the second node N2.

The fourth transistor M4 has a first electrode coupled to the second electrode of the second transistor M2, and a second electrode coupled to the second node N2. A gate electrode of the fourth transistor M4 is coupled to the nth scan line Sn. When the scan signal is supplied to the nth scan line Sn, the fourth transistor M4 is turned on, and thereby the second transistor M2 is connected in a diode form.

The fifth transistor M5 has a first electrode coupled to the data line Dm, and a second electrode coupled to the first node N1. A gate electrode of the fifth transistor M5 is coupled to the nth scan line Sn. When the scan signal is supplied to the nth scan line Sn, the fifth transistor M5 is turned on, thereby supplying the data signal received from the data line Dm to the first node N1.

The sixth transistor M6 has a first electrode coupled to the first power source ELVDD, and a second electrode coupled to the first node N1. A gate electrode of the sixth transistor M6 is coupled to the light emission control line En. The sixth transistor M6 is turned off when the light emission control signal is supplied to the light emission control line En. When the light emission control signal is not supplied to the light emission control line En, the sixth transistor M6 is turned on.

The seventh transistor M7 has a first electrode coupled to the second electrode of the second transistor M2, and a second electrode coupled to the anode electrode of the organic light emitting diode OLED. A gate electrode of the seventh transistor M7 is coupled to the light emission control line En. The seventh transistor M7 is turned off when the light emission control signal is supplied to the light emission control line En. When the light emission control signal is not supplied to the light emission control line En, the seventh transistor M7 is turned on.

The storage capacitor Cst is coupled between the first power source ELVDD and the second node N2. The storage capacitor Cst stores a voltage corresponding to the data signal.

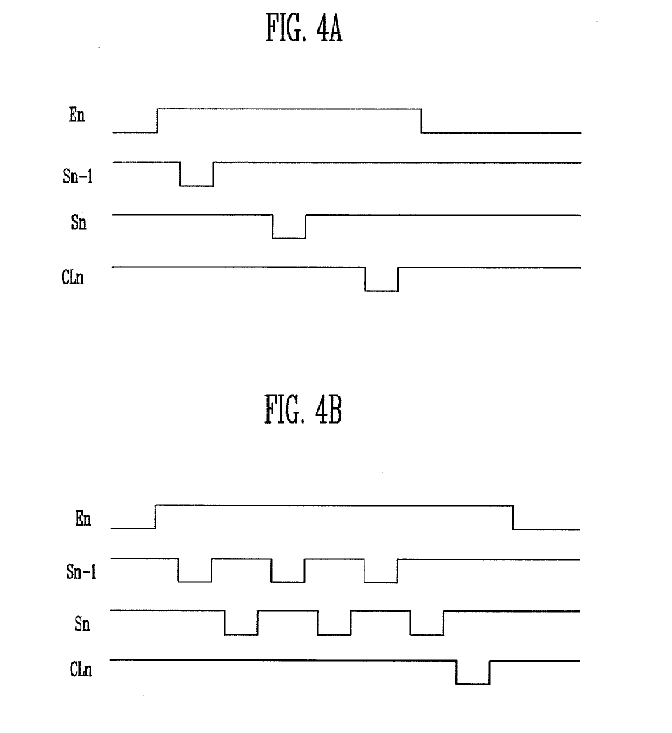

FIG. 4A is a waveform diagram illustrating a method of driving the pixel illustrated in FIG. 3.

Referring to FIG. 4A, the light emission control signal is supplied to the light emission control line En, and the sixth transistor M6 and the seventh transistor M7 are thereby turned off. If the sixth transistor M6 is turned off, the first power source ELVDD and the first node N1 are electrically blocked. If the seventh transistor M7 is turned off, the second transistor M2 and the organic light emitting diode OLED are electrically blocked. That is, while the light emission control signal is supplied, the pixel 142 is set to a non-light-emission state

Subsequently, the scan signal is supplied to the (n−1)th scan line Sn-1. When the scan signal is supplied to the (n−1)th scan line Sn-1, the third transistor M3 is turned on. When the third transistor M3 is turned on, the initialization power supply voltage Vint is supplied to the second node N2.

After the initialization power supply voltage Vint is supplied to the second node N2, the scan signal is supplied to the nth scan line Sn. When the scan signal is supplied to the nth scan line Sn, the fourth transistor M4 and the fifth transistor M5 are turned on. When the fourth transistor M4 is turned on, the second transistor M2 is configured as a diode (e.g., diode-connected). When the fifth transistor M5 is turned on, the data signal from the data line Dm is supplied to the first node N1. At this time, the second node N2 has been initialized to the initialization power supply voltage Vint, and the second transistor M2 is thereby turned on. Accordingly, a voltage, which is obtained by subtracting a threshold voltage of the second transistor M2 from a voltage of the data signal applied to the first node N1, is applied to the second node N2. At this time, the storage capacitor Cst stores a voltage applied to the second node N2.

After a voltage corresponding to the voltage of the data signal is stored in the storage capacitor Cst, the first transistor M1 is turned on according to the control signal supplied to the nth control line CLn. When the first transistor M1 is turned on, the initialization power supply voltage Vint is supplied to the anode electrode of the organic light emitting diode OLED. Accordingly, an organic parasitic capacitor/capacitance formed in the organic light emitting diode OLED is initialized.

If the organic parasitic capacitor is initialized, expressivity of black increases. In other words, if the organic parasitic capacitor is initialized, the organic light emitting diode OLED maintains a non-light-emission state in accordance with a leakage current, which is supplied from the pixel circuit 1421, and according to this, expressivity of black luminance may increase.

Subsequently, supply of the light emission control signal to the nth light emission control line En is stopped, and the sixth transistor M6 and the seventh transistor M7 are thereby turned on. When the sixth transistor M6 is turned on, the first power source ELVDD is supplied to the first node N1. When the seventh transistor M7 is turned on, the second electrode of the second transistor M2 is electrically coupled to the anode electrode of the organic light emitting diode OLED. At this time, the second transistor M2 controls an amount of a current flowing from the first power source ELVDD to the second power source ELVSS via the organic light emitting diode OLED, in accordance with the voltage stored in the storage capacitor Cst.

In practice, while repeating the aforementioned processes, the pixels 142 according to the present disclosure generate light with a luminance. In addition, two or more scan signals may be sequentially supplied to the plurality of scan lines S1 to Sn, as illustrated in FIG. 4B. At this time, the data driver 120 supplies the data signal to the mth data line, which is synchronized with the last scan signal that is supplied to the nth san line Sn, and according to this, an unwanted data signal may be finally stored in the pixel 142.

Meanwhile, in the present disclosure, the scan signal that is supplied from the (n−1)th scan line Sn-1, and the scan signal that is supplied from the nth scan line Sn, may be respectively supplied from different scan drive units. The pixel circuit 1421 may be configured by various circuits that are able to supply a current to the organic light emitting diode OLED.

FIG. 5 is a diagram illustrating the dummy pixel according to an embodiment of the present disclosure. For the sake of convenience of description, FIG. 5 illustrates the dummy pixel coupled to the nth repair line Rn.

Referring to FIG. 5, the dummy pixel 144 according to an embodiment of the present disclosure includes a dummy pixel circuit 1441 and a coupling unit 1442.

The dummy pixel circuit 1441 supplies a current to the repair line Rn, in accordance with the data signal supplied from the dummy data line DDk. The dummy circuit 1441 may have the same configuration as the pixel circuit 1421 of the pixel 144. In addition, the dummy pixel circuit 1441 may be configured by various types of pixel circuits that are able to supply currents in accordance with the data signal.

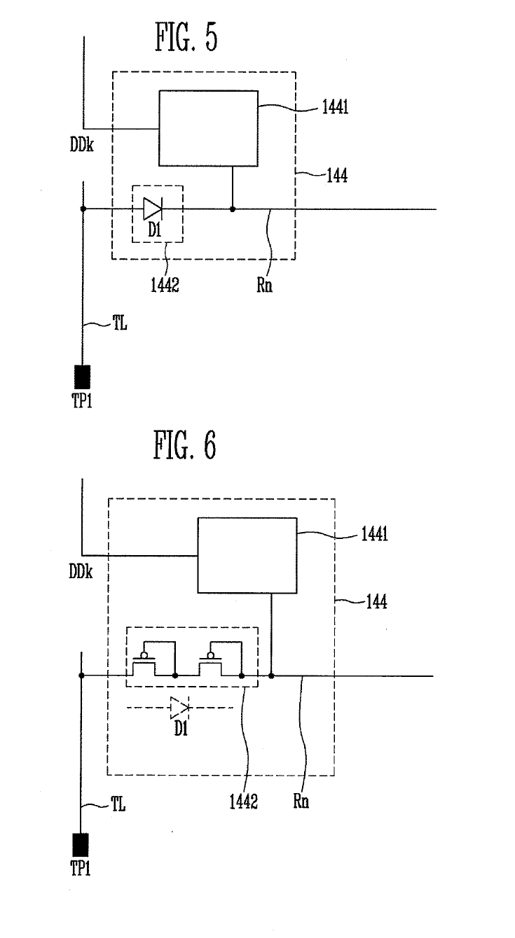

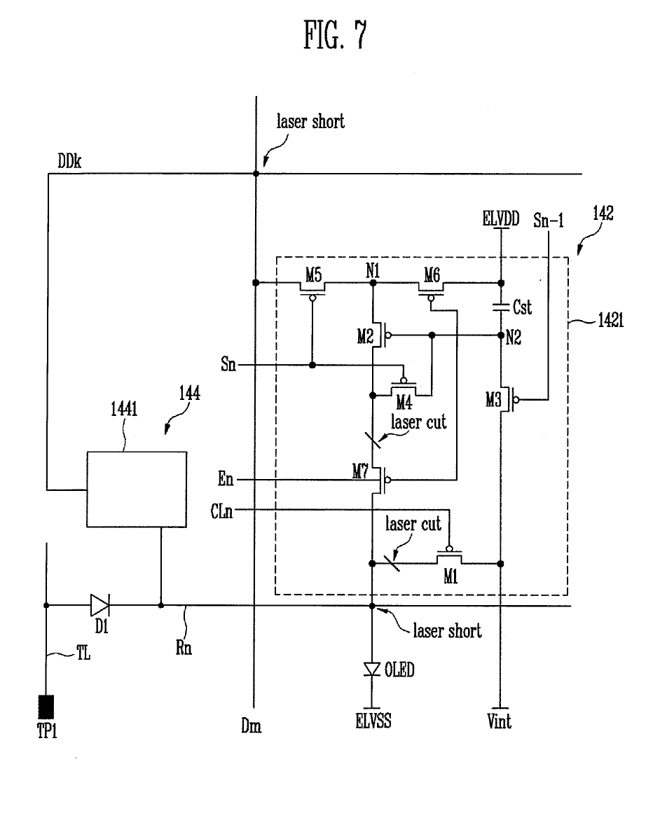

The coupling unit 1442 is coupled between the repair line Rn and the test line TL. The coupling unit 1442 includes a diode D1. The diode D1 is configured such that a current flows from the test line TL to the repair line Rn. For example, the diode D1 may instead be at least one transistor that is configured as a diode (e.g., a diode-connected transistor), as illustrated in FIG. 6.

FIG. 7 is a diagram illustrating a repairing method according to an embodiment of the present disclosure. In FIG. 7, a pixel 142, which is illustrated as being coupled to the nth scan line Sn and to the mth data line Dm, fails. Accordingly, the pixel 142, whose failure is detected during inspection, is repaired.

Repair processing will be described hereinafter in detail. The pixel circuit 1421 of the pixel 142 is electrically decoupled from the organic light emitting diode OLED, using a laser-cut process. For example, the first transistor M1 and the seventh transistor M7 may be electrically decoupled from the first power source ELVDD and the initialization power supply voltage Vint, respectively, using the laser-cut process.

The repair line Rn is electrically coupled to the organic light emitting diode OLED of the pixel 142, using a laser-short process. In addition, the dummy data line DDk is electrically coupled to the mth data line Dm, using the laser-short process.

Accordingly, the dummy pixel 144 controls a current that is supplied to the organic light emitting diode OLED of the pixel 142 in accordance with the data signal that is supplied to the mth data line Dm. In this case, the organic light emitting diode OLED of the pixel 142 may stably emit light with desired luminance, regardless of the failure of the pixel circuit 1421.

Meanwhile, after the aforementioned laser processes, an additional inspection is performed to check whether electrical coupling between the dummy pixel 144 and the organic light emitting diode OLED is made.

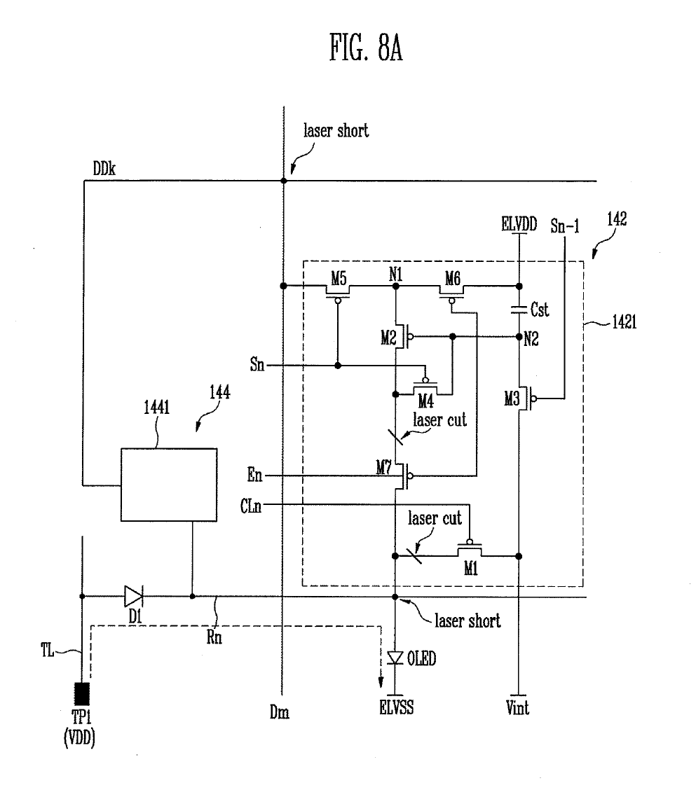

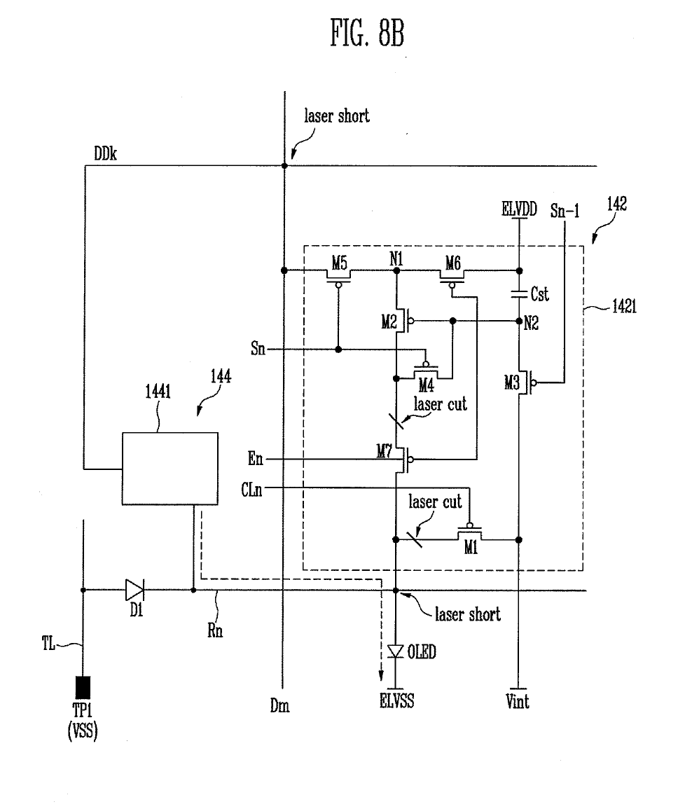

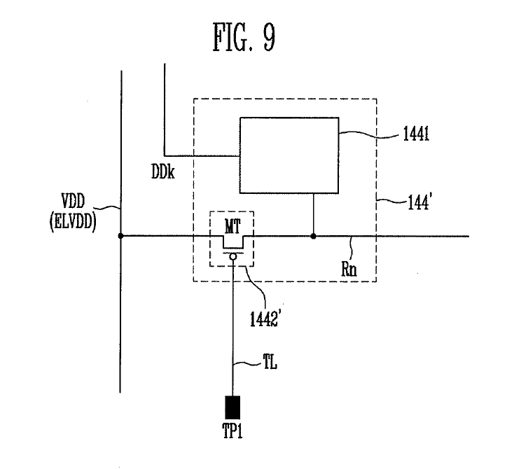

FIG. 8A is a diagram illustrating an embodiment of a method of inspecting electrical coupling between the dummy pixel and the organic light emitting diode.

Referring to FIG. 8A, a high potential voltage VDD is supplied to the first test pad TP1 during inspection. The high potential voltage VDD is set to a voltage that is higher than the second power source ELVSS. For example, the high potential voltage VDD may be set to a voltage at which the organic light emitting diode OLED emits light.

During inspection, the data driver 120 supplies a black data signal to the plurality of data lines D1 to Dm. If a black data signal is supplied to the plurality of data lines D1 to Dm, the plurality of pixels 142 and the plurality of dummy pixels 144 emit light with black luminance.

The high potential voltage VDD supplied to the first test pad TP1 is supplied to the diode D1 via the test line TL. If the high potential voltage VDD is supplied to the diode D1, the diode D1 is activated, and the high potential voltage VDD is thereby supplied to the anode electrode of the organic light emitting diode OLED. If the high potential voltage VDD is supplied to the anode electrode of the organic light emitting diode OLED, the organic light emitting diode OLED emits light.

During inspection, if the organic light emitting diode OLED emits light, it is determined that the repair process is successful. Conversely, during inspection, if the organic light emitting diode OLED does not emit light, it is determined that the repair process has failed.

Meanwhile, the dummy pixel 144 that is repaired receives the data signal from the mth data line Dm via the dummy data line DDk during a normal drive period, as illustrated in FIG. 8B. After receiving the data signal from the mth data line Dm, the dummy pixel 144 supplies a current to the organic light emitting diode OLED of a pixel 142 in accordance with the data signal.

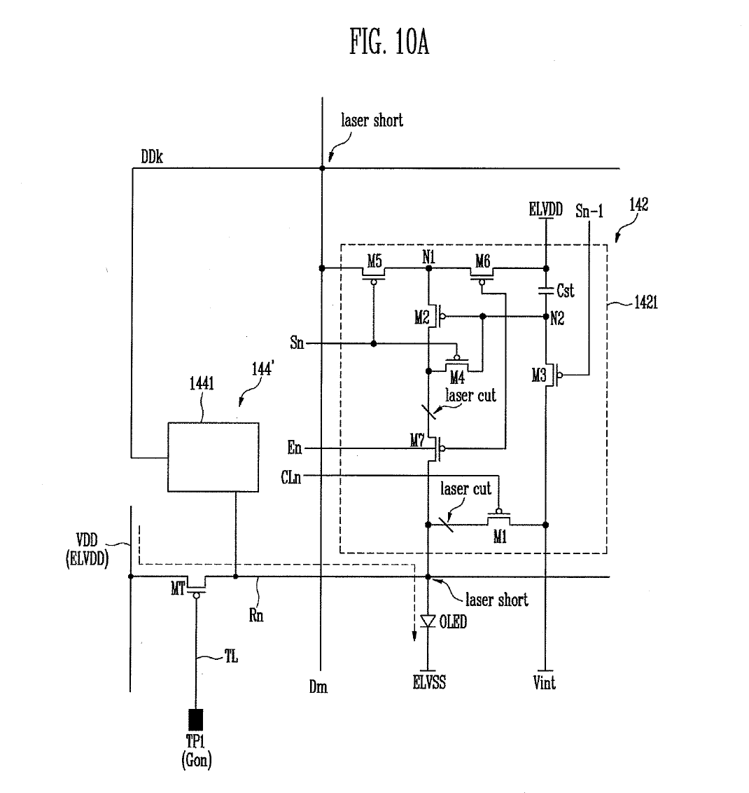

FIG. 9 is a diagram illustrating the dummy pixel according to another embodiment of the present disclosure. In FIG. 9, the same symbols or reference numerals will be attached to the same elements depicted in FIG. 5, and detailed description thereof will be omitted.

Referring to FIG. 9, a dummy pixel 144′ according to another embodiment of the present disclosure includes the dummy pixel circuit 1441 and the coupling unit 1442′.

The coupling unit 1442′ includes an inspection transistor MT that is coupled between the high potential voltage VDD and the repair line Rn. A gate electrode of the inspection transistor MT is coupled to the first test pad TP1 via the test line TL. The inspection transistor MT is turned on when a gate-on voltage is supplied to the first test pad TP1. The high potential voltage VDD is set to a voltage that is higher than the second power source ELVSS, and can turn the organic light emitting diode OLED on. For example, the high potential voltage VDD may be set to be the same as the voltage of the first power source ELVDD.

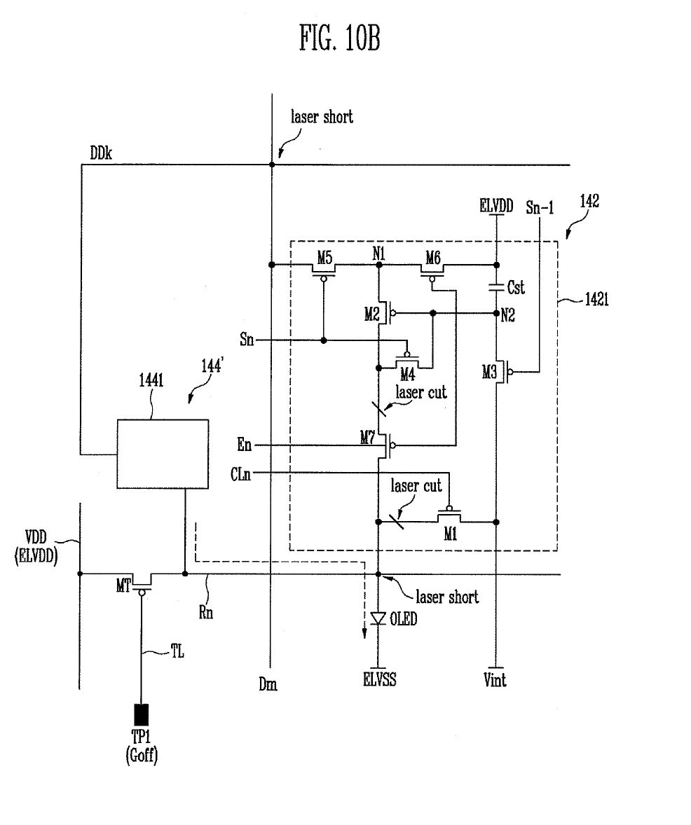

FIG. 10A is a diagram illustrating another embodiment of a method of inspecting electrical coupling between the dummy pixel and the organic light emitting diode.

Referring to FIG. 10A, during inspection, a gate-on voltage “Gon” is supplied to the first test pad TP1 to thereby turn the inspection transistor MT on.

In addition, during inspection, the data driver 120 supplies a black data signal to the plurality of data lines D1 to Dm. If the black data signal is supplied to the plurality of data lines D1 to Dm, the organic light emitting diodes OLEDs corresponding to the plurality of pixels 142 and the plurality of dummy pixels 144′ emit light with black luminance.

If the inspection transistor MT is turned on, the high potential voltage source VDD is supplied to the organic light emitting diode OLED, and thereby the organic light emitting diode OLED emits light. During inspection, if the organic light emitting diode OLED emits light, it is determined that the repair process is successful. Conversely, if the organic light emitting diode OLED does not emit light during inspection, it is determined that the repair process has failed.

Meanwhile, the dummy pixel 144′ that is repaired receives the data signal from the mth data line Dm via the dummy data line DDk during a normal drive period, as illustrated in FIG. 10B. Subsequently, the dummy pixel 144′ supplies a current to the organic light emitting diode OLED of the pixel 142 in accordance with the data signal.

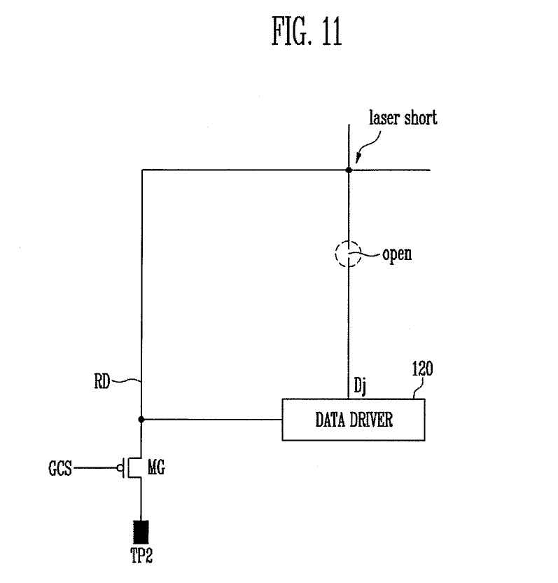

FIG. 11 is a diagram illustrating repair processing of the data line using a ring data line.

Referring to FIG. 11, if the data line is opened (e.g., electrically discontinuous), the ring data line RD may be used for repairing. For example, if the jth (j is a natural number) data line Dj is opened, the ring data line RD is electrically coupled to an end of the data line Dj using the laser-short process. In addition, the data driver 120 supplies the data signal, which is the same as that of the jth data line Dj, to the dummy channel.

Accordingly, the one end of the jth data line Dj receives the data signal from the ring data line RD, and the other end of the jth data line Dj receives the data signal from the data driver 120. Thus, even if an intermediate portion of the jth data line Dj is opened, the pixels coupled to the jth data line Dj stably emit light with desired luminance.

Additionally, during inspection, a gate transistor MG is turned on in accordance with a gate control signal GCS. At this time, it is possible to check whether coupling is made between the ring data line RD and the data line Dj by supplying a voltage via the second test pad TP2. In addition, during a normal drive period, the gate transistor MG is maintained to be turned off. Accordingly, the ring data line RD may receive the data signal, which is the same as that of the jth data line Dj, from the dummy channel.

Meanwhile, in the present disclosure, all of the transistors are illustrated as PMOS transistors, for the sake of convenience of description, although the present disclosure is not limited thereto. For example, some or all of the transistors may be NMOS transistors.

In addition, in the present disclosure, the organic light emitting diode OLED may emit various types of light (e.g., light including red, green, and blue) in accordance with an amount of current supplied from the driving transistor, although the present disclosure is not limited thereto. For example, the organic light emitting diode OLED may emit white light in accordance with an amount of current that is supplied from the driving transistor, and a color image may be displayed by using color filters or the like.

According to a display device and a method of repairing the display device of the embodiments of the present disclosure, it is possible to check whether an organic light emitting diode coupled to a dummy pixel is normally driven by using a coupling unit of a pixel.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of skill in the art that various changes in form and details may be made without departing from the spirit and scope of the present invention as set forth by the following claims and their equivalents.

What is claimed is:

1. A display device comprising:
a plurality of pixels at respective crossing regions of data lines and scan lines in an active display area;
a plurality of repair lines in parallel with the scan lines in the active display area;
one or more dummy pixels in an area outside the active display area and coupled to a respective one of the repair lines;
one or more dummy data lines that are respectively coupled to the one or more of the dummy pixels, and that overlap the data lines; and
a test line coupled between a first test pad and the dummy pixels,
wherein one of the dummy pixels at an ith (i is a natural number) horizontal line comprises:
a dummy pixel circuit between a kth (k is a natural number) dummy data line of the dummy data lines and an ith repair line of the repair lines; and
a coupling unit coupled between the ith repair line and the test line.

2. The display device according to claim 1, wherein one or more of the one or more dummy pixels are located at each horizontal line.

3. The display device according to claim 1, wherein the coupling unit comprises a diode that is configured to allow current to flow from the test line to the ith repair line.

4. The display device according to claim 1, wherein the coupling unit comprises at least one diode-connected transistor.

5. The display device according to claim 1, wherein the coupling unit comprises an inspection transistor coupled between a high potential voltage source and the ith repair line.

6. The display device according to claim 5, wherein each of the plurality of pixels is configured to emit light while controlling an amount of a current that flows from a first power source to a second power source via an organic light emitting diode.

7. The display device according to claim 6, wherein a voltage of the high potential voltage source is higher than a voltage of the second power source.

8. The display device according to claim 6, wherein the high potential voltage source is the first power source.

9. The display device according to claim 5, wherein a gate electrode of the inspection transistor is coupled to the test line.

10. The display device according to claim 1, wherein, when an ith pixel of the pixels at an ith horizontal line fails:
the ith repair line is configured to be electrically coupled to an organic light emitting diode of the ith pixel; and
the kth dummy data line is configured to be electrically coupled to a data line of the data lines coupled to the ith pixel.

11. The display device according to claim 1, further comprising a data driver that is configured to supply a data signal to the data lines.

12. The display device according to claim 11, further comprising:
one or more ring data lines electrically coupled to a dummy channel of the data driver and overlapping the data lines; and
a gate transistor coupled between the ring data line and a second test pad.

13. The display device according to claim 12, wherein, when a jth (j is a natural number) data line of the data lines is opened:
the ring data line is configured to be electrically coupled to the jth data line; and
the data driver is configured to supply a data signal, which is the same as a data signal corresponding to the jth data line, to the dummy channel.

14. A method of repairing a display device comprising a pixel at an ith (i is a natural number) horizontal line, and comprising an organic light emitting diode and a pixel circuit for supplying a current to the organic light emitting diode, the method comprising:
electrically decoupling the pixel circuit from the organic light emitting diode when the pixel fails;
electrically coupling a dummy data line, which is coupled to a dummy pixel, to a data line coupled to the pixel;
electrically coupling a repair line, which is coupled to the dummy pixel, to an anode electrode of the organic light emitting diode; and
inspecting whether the organic light emitting diode emits light by using a coupling unit coupled to the repair line.

15. The method of repairing the display device according to claim 14, wherein the coupling unit comprises a diode configured to allow a current to flow from a first test pad to the repair line.

16. The method of repairing the display device according to claim 15, wherein the inspecting whether the organic light emitting diode emits light comprises supplying a high potential voltage to the first test pad.

17. The method of repairing the display device according to claim 14, wherein the coupling unit comprises an inspection transistor between the repair line and a high potential voltage source.

18. The method of repairing the display device according to claim 17, wherein the inspecting whether the organic light emitting diode emits light comprises turning on the inspection transistor to supply a voltage of the high potential voltage source to the organic light emitting diode.

19. The method of repairing the display device according to claim 17, wherein the high potential voltage source is a voltage by which the organic light emitting diode emits light.

20. The method of repairing the display device according to claim 14, further comprising supplying a data signal corresponding to black to the data line during the inspecting whether the organic light emitting diode emits light.
